(19) United States
(12) Patent Application Publication
(10) Pub. No.: US 2003/0037853 A1
(43) Pub. Date: Feb. 27, 2003

(54) Wheel with rim having seats inclined towards the outside and produced by an extrusion process

(75) Inventors: Thomas Emberger, Kipfenberg (DE); Denis Alff, Riom (FR)

Correspondence Address: BAKER BOTTS LLP, 44 TH FLOOR, 30 ROCKEFELLER PLAZA, NEW YORK, NY, 10112-0228, US

(73) Assignee: Michelin Recherche et Technique S.A.

(21) Appl. No.: 10/211,658

(22) Filed: Aug. 2, 2002

Related U.S. Application Data
(63) Continuation of application No. PCT/EP01/14624, filed on Dec. 12, 2001.

(30) Foreign Application Priority Data
Dec. 13, 2000 (FR) 00/16811

(51) Int. Cl. B60B 21/10

(52) U.S. Cl. 152/379.3

(57) ABSTRACT

A wheel, having first and second bead seats which are inclined towards the outside and a cylindrical wall intended for supporting a support ring, constituted by the assembly of:

a disc comprising a hub bearing surface, a transition zone and a radially outer edge, the geometry of which constitutes the first seat and a first part of the cylindrical wall, and

a rim comprising a plurality of cavities and being such that its radially outer wall corresponds to the second seat and to the complementary part of the cylindrical wall;

the assembly being effected at the end of the rim on the side of the disc at the level of the cylindrical wall, on one hand, and at the level of the end of the radially inner wall of the rim, on the other hand.

### CROSS-REFERENCE TO RELATED APPLICATIONS

This is a continuation of international application No. PCT/EP 01/14624 filed Dec. 12, 2001, published in French as international publication No. WO 02/47923 A2 and claiming priority of French application No. 00/16811 filed Dec. 13, 2000.

### BACKGROUND OF THE INVENTION

1. Technical Field of the Invention

The present invention concerns a wheel, composed of a disc and a rim, for a tire, and able to form, with a support ring for the tread of the tire and the tire, a rolling assembly which may be useful in the case of travelling when the inflation pressure drops abnormally relative to the normal pressure of use (referred to as rated service pressure) or even becomes zero.

2. The Related Art

The main difficulties encountered in the case of travelling with a flat tire or at low pressure relate to the risk of unwedging of the beads of the tire and, in particular, the unwedging of the outside bead of the tire mounted on the outside of the vehicle during cornering. The well-known proposed techniques for avoiding such unwedging, and in particular that consisting of arranging axially to the inside of the outer rim seat a protrusion or hump of low height, do not appear to give complete satisfaction and tend to increase the difficulties of mounting and dismounting the tires.

U.S. Patent Application Publication US 2001/0020506 describes, by way of example, in order to solve the above problem effectively, an integral wheel such as shown in FIG. 1. This wheel has a radially outer geometry comprising first and second seats which are intended to receive tire beads, at least the first seat having a generatrix whose axially outer end is on a circle of diameter less than the diameter of the circle on which the axially inner end is located. The seats are extended axially to the outside by a protrusion or “hump” of low height. The first seat is extended axially to the inside by a cylindrical wall intended to receive a tread support ring. This wheel is such that the cylindrical wall is formed of first and second zones that are separated by a circumferential groove opening radially outwardly. It may be produced by molding an aluminium alloy in a single operation.

The presence of the circumferential groove is intended to reduce significantly the weight of the wheel. This wheel, which is optimized in terms of weight, does however have the drawback of, when the outer profile comprises a mounting groove for a tire, permitting the accumulation, beneath the axially outer portion relative to the mounting groove of the inner profile of the rim of the wheel, of all sorts of materials, such as mud mixed to a greater or lesser extent with stones or snow or ice in winter conditions, which are difficult to evacuate.

### SUMMARY OF THE INVENTION

In order to make it possible to obtain optimum lightness and to overcome the above drawbacks, a wheel, according to the invention, has a radially outer geometry comprising first and second seats intended to receive a tire bead. At least the first seat has a generatrix whose axially outer end is on a circle of diameter less than the diameter of the circle on which the axially inner end is located. Both of the first and second seats are extended axially to the outside by a protrusion or hump of low height, and the first seat is extended axially to the inside by a cylindrical wall. In accordance with the invention, the wheel is formed by the assembly:

of a disc comprising a hub bearing surface, a transition zone and a radially outer edge, the geometry of which constitutes the first seat and a first part of the cylindrical wall, and

of a rim comprising a plurality of cavities and being such that the radially outer wall of the rim corresponds to the second seat, to the hump and to the second part of the cylindrical wall;

the assembly being effected at the end of the rim on the side of the disc at the level of the cylindrical wall, on one hand, and at the level of the end of the radially inner wall of the rim, on the other hand.

Preferably, the radially inner wall of the rim has a diameter which gradually decreases from the second seat as far as the zone of assembly with the disc.

The wheel according to the invention has numerous advantages. The fact that the rim comprises a plurality of cavities of variable shapes makes it possible to dissociate its radially outer and inner profiles. It is thus possible to associate an inner profile which guarantees no retention of water, ice or various materials with an outer profile having a mounting groove of depth suitable for easy mounting and dismounting of the tire intended to be fitted on the wheel. The cavities permit a substantial reduction in the weight of the rim while retaining an inertia of the axially inner part of the rim which is very satisfactory.

The production of the wheel in two parts also gives the disc great freedom of style which may be effected by any appropriate molding, forging, etc. process.

Preferably, the rim of the wheel is produced by extrusion, bending and welding at least one metallic profiled element, preferably of aluminium alloy. Other materials may be suitable, in particular materials such as steel, or alloys of titanium, magnesium, or alternatively an alloy of aluminium, zinc, magnesium and copper referred to as ZAMAC.

This manufacturing process has the advantage of being faster than a molding process, and also makes it possible to use materials having mechanical and fatigue properties that are significantly improved compared with the aluminium alloys conventionally used in a molding process.

One embodiment of the assembly is such that the rim comprises a first substantially cylindrical extension of geometry suitable, for cooperating with the radially outer edge of the disc for completing the cylindrical wall adjacent to the first seat and constituting a first connection zone between the disc and the rim, and a second substantially cylindrical extension arranged radially internally relative to the first extension, of a geometry suitable for cooperating with the axially inner wall of the outer edge of the disc and constituting a second connection zone between the disc and the rim.

Advantageously, the geometries of the first cylindrical extension and of the outer edge of the disc are adapted to come to bear axially against one another. The axially inner geometry of the outer edge of the disc may also comprise a cylindrical radially-outer wall bearing surface intended to receive the radially inner wall of the second extension of the rim.

The assembly may also comprise a weld bead connecting the axially inner end of the bearing surface of the outer edge of the disc and the radially inner wall of the second extension of the rim. A second weld bead may connect the axially inner end of the first part of the cylindrical wall and the complementary part thereof.

According to one advantageous embodiment, the first and second extensions of the rim belong to the axially-outermost cavity of the rim. This embodiment has the advantage of mechanically reinforcing the assembly zone, which also improves its rigidity and facilitates meeting the tolerances of industrial manufacture.

### BRIEF DESCRIPTION OF THE DRAWINGS

A number of embodiments will now be described, in non-limitative manner, with reference to the appended drawings, in which:

FIG. 1 shows the wheel of FIG. 3 of Patent Appln. Pub. US 2001/0020506, viewed in meridian section;

FIG. 2 is a view in meridian section of a first embodiment of a wheel according to the invention;

FIG. 3 is a view in meridian section of a variant of the embodiment of FIG. 2;

FIG. 4 is a view in meridian section through a second embodiment of a wheel according to the invention;

FIG. 5 is a view in meridian section through a third embodiment of a wheel according to the invention; and

FIG. 6 is a view in meridian section of a variant of the third embodiment of FIG. 5.

### DETAILED DESCRIPTION OF EXEMPLARY EMBODIMENTS

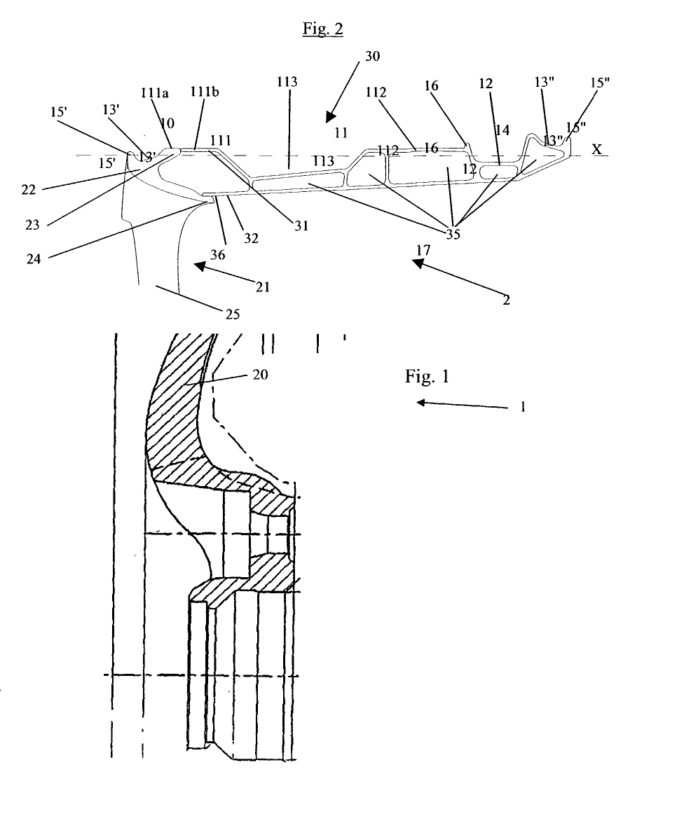

FIG. 1 shows, in a meridian diagrammatic view, an integral wheel 1 as disclosed by Patent Appln. Pub. US 2001/0020506. This wheel comprises a rim 10 and a disc 20. The rim 10 comprises two rim seats, an axially-outer one 13′ and an axially-inner one 13″, the generatrices of which are inclined towards the outside. The two seats are extended externally by protrusions, “humps” or flanges 15′ and 15″. The axially-outer seat 13′ is extended axially towards the inside by a cylindrical wall or bearing surface 11, which itself is provided at its other end with a stop 16 for positioning a support ring intended to be mounted on the bearing surface 11. The inner seat 13″ is extended axially to the inside by a rim flange 14, which flange defines a mounting groove 12 together with the positioning stop 16. The bearing surface 11 comprises two parts 111 and 112 which are separated axially by a circumferential groove 113 opening radially outwardly. The diameters of the two seats 13′ and 13″ are not identical: the first seat 13′, which is arranged on the outer side of the wheel 1 as mounted on a vehicle, has a diameter less than that of the second seat 13″. This makes it possible to reduce the depth of the mounting groove 12.

The two parts 111 and 112 of the cylindrical wall or bearing surface 11 are adapted to support a support ring of the tread of the tire intended to be fitted on the wheel. Such rings are, by way of example, described in U.S. Pat. No. 5,891,279 and copending U.S. patent application Ser. No. 10/008,198.

The circumferential groove 113 makes it possible to reduce substantially the weight of the wheel 1 and facilitates the production thereof. Despite the limited depth of the mounting groove 12, this wheel has radially internally a zone 17 adjacent to the mounting groove 12 that is favorable to the accumulation of various materials.

FIG. 2 shows a first embodiment of a wheel according to the invention. In FIG. 2 as in the subsequent figures, like parts are identified by the same reference numbers. The wheel 2, which is an integral wheel, is formed by the assembly of a disc 21 and a rim 30. The radially outer geometry of the wheel 2 is similar to that of the wheel 1 of FIG. 1: there are, in particular, two seats 13′ and 13″, extended axially externally by two humps 15′ and 15″, a cylindrical wall comprising two parts 111 and 112 which are separated by a circumferential groove 113, and a mounting groove 12.

On the other hand, the radially inner profile of the wheel 2 is substantially different from that of FIG. 1, in that the diameter decreases continuously between the inner seat 13″ and the convection to the transition zone 25 of the disc 21. As may be seen, this profile does not have any zone favorable to the accumulation of various materials. This result is obtained owing to the presence in the rim of a plurality of cavities 35, the radially outer profile of which corresponds to the profile of the rim of the wheel 1, and the radially inner profile of which has a monotonous variation. The cavities 35 make it possible to dissociate completely the radially inner and outer profiled elements of the wheel.

The disc 21 comprises an outer edge 22, the radially outer geometry of which corresponds to an outer seat 13′, to a hump 15′ and to a first part of the cylindrical wall or bearing surface 111a which are similar to those of the wheel 1. The outer edge 22 has a U-shaped axially inner profile, between the part 23, at the level of the part 111a of the cylindrical wall, and the part 24, at the level of the radially inner profile of the rim 30. This U-shaped profile has the advantage of substantially reducing the mass of material beneath the outer seat 13′, which greatly reduces the weight of the wheel. Such a weight reduction cannot be obtained simply with a wheel such as 1.

The rim 30 comprises a plurality of cavities 35 that are extended axially outwardly by the extension 31, the radially outer wall of which is partly at the level of the cylindrical wall 111b, and the extension 32. The extension 31 comes to bear against the part 23 of the outer edge 22 of the disc 21. This makes it possible to define precisely the axial position of the disc 21 relative to the rim. The extension 32 comes to bear against the radially outer wall of the part 24 of the outer edge 22 of the disc 21. This makes it possible to center the rim precisely relative to the disc 21 during assembly. A weld bead 36 is formed after assembly. The weld bead 36 is preferably a fillet weld to provide a very airtight weld.

In the case of a wheel dimension of 255×500 A, a comparison of the masses between the wheels 1 and 2 yields a reduction in mass of the order of 2 kg to the advantage of the wheel 2. This corresponds to a saving in mass of 15%. 255 is the width of the wheel and 500 the nominal diameter of the wheel, in millimeters. A stands for asymmetrical (the two seats are of different diameters). The nominal diameter of the wheels corresponds to the axis X in all of the figures.

The rim 30 is obtained by extrusion, bending and welding of at least one section of metallic profiled element, for example of aluminium alloy.

This profiled element is conventionally obtained by spinning or extrusion of aluminium alloy through a die having the dimensions and the forms of the cross-section of the profiled element to be produced.

The profiled element is then cut to length, and then bent. For example, two semicircles of profiled element may be bent, then they may be joined by welding to obtain the rim, such as illustrated at 30.

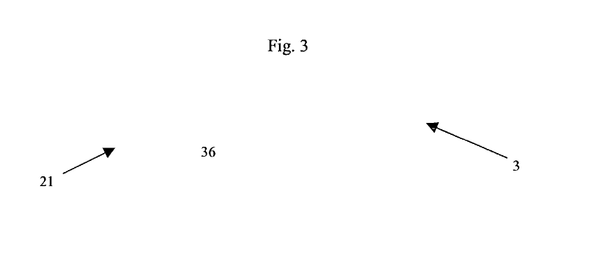

FIG. 3 shows a wheel 3 which is a variant embodiment of the wheel 2. The rim 40 of wheel 3 is distinguished from the rim 30 of FIG. 2 by the geometry of the end in contact with the disc 21. The extensions 41 and 43 have their ends connected by a rib 42. Consequently, these three parts form a cavity 44 with the adjacent wall of the adjacent cavity 35. This complementary rib 42 mechanically reinforces the assembly zone.

The assembly between the disc 21 and the rim 40 of the wheel 3 comprises a second weld bead 37 arranged radially outwardly and connecting the extension 41 of the rim to the part 23 of the outer edge of the disc. This second weld bead 37 has the advantage of mechanically reinforcing the strength of the assembly. If necessary, slight machining is carried out to guarantee that the weld 37 does not extend radially beyond the external diameter of the cylindrical wall 11.

The circumferential groove 113 of the two wheels 2 and 3 may in particular serve for putting in place a wheel module including a pressure sensor of a system for monitoring the pressure of the tires of a vehicle. Such location does not in any way disturb the mounting and the dismounting of the tire.

The supports intended to be slipped on to the cylindrical wall 11 conventionally have a width such that they bear on the two parts 111 and 112 of the wall 11 or bearing surface.

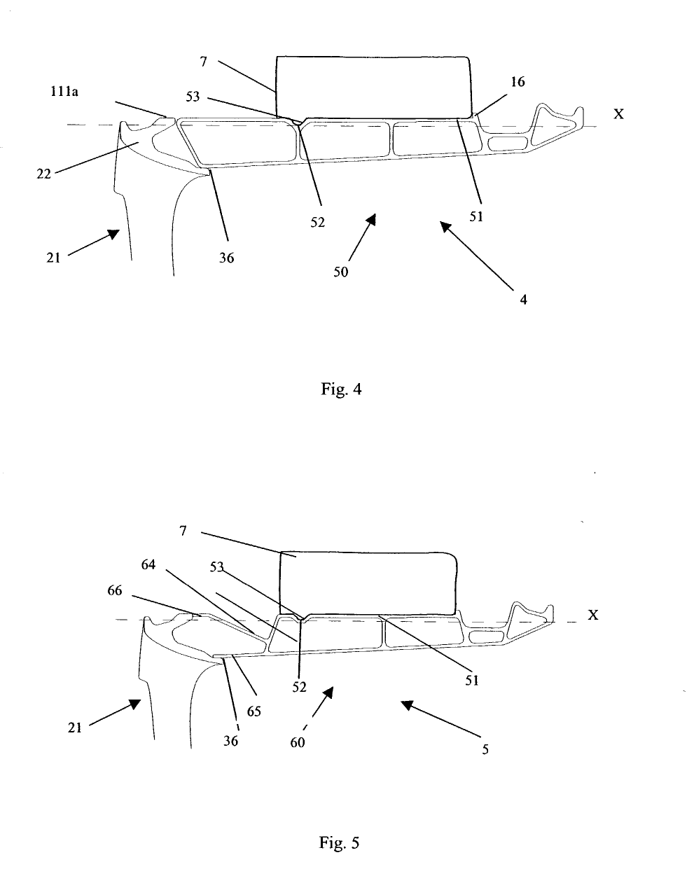

FIG. 4 shows a second embodiment of a wheel according to the invention. The wheel 4 has a radially outer profile adapted to cooperate with a support ring 7 of greatly reduced weight compared with the previous rings. The outer profile of the rim 50 comprises a cylindrical wall or bearing surface 51 directly connecting the part 111a of the outer edge 22 of the disc 21 to the blocking stop 16. The support ring 7 has a reduced width and comprises, in order to remain in place during travel, a circumferential elastic rib 53 intended to fill a suitable circumferential groove 52 formed on the outer profile of the rim 50, when the ring 7 is slipped on to the bearing surface 51.

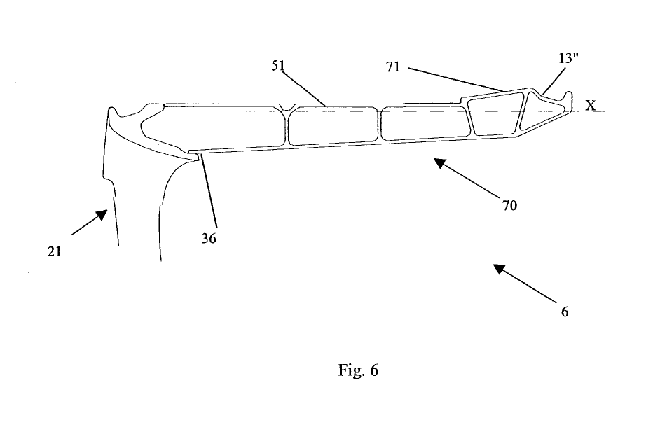

FIG. 5 shows a variant of the wheel 4. In this variant 5, the assembly with the disc 21 is ensured, on the side of the rim 60, by two separate cylindrical extensions 65 and 66 as in the case of the wheel 2. To facilitate the slipping of the ring 7 around the cylindrical wall 51, a radially outwardly opening circumferential groove 64 is provided between the radially outer assembly zone 66 and the bearing surface 51.

FIG. 6 shows a third embodiment of a wheel 6 according to the invention. The wheel 6 is formed by the assembly of a disc 21 and a rim 70. The radially outer profile of the wheel 6 does not comprise a mounting groove. Instead, this profile has at the level of the rim 70 a frustoconical zone 71 arranged between the axially inner seat 13″ and the cylindrical bearing surface 51. This frustoconical zone 71 acts as a zone of passage for the second bead of the tire which is intended to come into position on the inner seat 13″. This profile permits rapid mounting of the tire and of the support ring 7 on the wheel 6 by slipping the whole around the cylindrical wall 51 axially towards the inside.

All the examples shown, in non-limitative manner, demonstrate the advantage of the dissociation of the inner and outer profiles of the wheel linked to the process selected for producing the rims. All together, they also demonstrate the flexibility which the designer of the wheel has to meet his needs.

What is claimed is:

1. A wheel having a radially outer geometry which comprises a first seat and a second seat for receipt of the beads of a tire to be mounted on the wheel, at least the first seat having a generatrix, the axially outer end of which is on a circle of diameter less than the diameter of the circle on which the axially inner end is located, each of said first and second seats being extended axially to the outside by a protrusion of low height, said first seat being extended axially to the inside by a cylindrical wall forming a bearing surface for a tread support ring, wherein said wheel is formed by an assembly of:
(a) a disc comprising a hub bearing surface, a transition zone and a radially outer edge, the geometry of said outer edge comprising said first seat and a first part of said cylindrical wall, and
(b) a rim comprising a radially inner wall, a radially outer wall and a plurality of cavities therebetween, said rim being configured such that the radially outer wall thereof corresponds to said second seat, to said protrusion of said second seat and to a second part of said cylindrical wall, said disc being assembled to said rim in a zone of assembly at one axial end of said rim;
said assembly being effected at said one end of said rim on the side of the disc at the level of said cylindrical wall, on one hand, and at the level of the end of the radially inner wall of said rim, on the other hand.

2. A wheel according to claim 1, in which the radially inner wall of the rim has a diameter which gradually decreases from said second seat as far as the zone of assembly of the rim with the disc.

3. A wheel according to claim 1, in which said rim comprises a first substantially cylindrical extension, having a geometry suitable for cooperating with the radially outer edge of the disc for completing said cylindrical wall adjacent to said first seat and constituting a first connection zone between the disc and the rim, and a second substantially cylindrical extension arranged radially internally relative to said first cylindrical extension, having a geometry suitable for cooperating with the axially inner wall of the outer edge of the disc for constituting a second connection zone between the disc and the rim.

4. A wheel according to claim 3, in which the geometries of said first cylindrical extension and of the outer edge of the disc are adapted to bear axially against one another.

5. A wheel according to claim 3, in which the axially inner geometry of the outer edge of the disc comprises a cylindrical radially outer wall bearing surface intended to receive the radially inner wall of said second cylindrical extension of said rim.

6. A wheel according to claim 5, comprising a weld bead connecting the axially inner end of the bearing surface of the outer edge of the disc and the radially outer wall of the second cylindrical extension of the rim.

7. A wheel according to claim 3, comprising a weld bead connecting the axially inner end of the first part of said cylindrical wall and the complementary part of said cylindrical wall.

8. A wheel according to claim 3, in which said first and second cylindrical extensions of said rim enclose at least in part the axially-outermost cavity of said rim.

9. A wheel according to claim 1, in which the radially outer profile of said rim comprises a circumferential mounting groove.

10. A wheel according to claim 1, in which the radially outer profile of said rim comprises a circumferential groove arranged between two parts of said cylindrical bearing surface.

11. A wheel according to claims 1, in which the radially outer profile of said cylindrical bearing surface of said rim comprises a circumferential groove.

12. A wheel according to claims 1, in which said rim is produced by extrusion and then bending and welding a metallic profiled element.

13. A wheel according to claim 12, in which the profiled element is composed of aluminium alloy.
